(19) United States
(12) Patent Application Publication
(10) Pub. No.: US 2002/0083436 A1
(43) Pub. Date: Jun. 27, 2002

(54) Method for a commercial-free, televised game show

(76) Inventor: William J. Fidler, Philadelphia, PA (US)

Correspondence Address: DILWORTH PAXSON LLP, 3200 MELLON BANK CENTER, 1735 MARKET STREET, PHILADELPHIA, PA, 19103, US

(21) Appl. No.: 10/000,278

(22) Filed: Nov. 1, 2001

Related U.S. Application Data
(60) Provisional application No. 60/245,135, filed on Nov. 2, 2000.

(51) Int. Cl. H04N 7/16; H04H 9/00

(52) U.S. Cl. 725/22

(57) ABSTRACT

This invention provides methods for conducting a commercial-free, network-televised game show, supported by revenue from commercial advertisers, but free of commercial interruption. Also provided are the resulting game show, and a novel method of producing revenue from such a commercial-free, network-televised game show. The show generates revenue from both the network broadcast and the Internet. However, the generation of revenue is unique when compared with standard, advertisement-based television protocols, and the format of the show is novel because advertising is an integral and continuous part of the show. Revenue-generating advertisements and entertainment are integrated, and the show is continuous in its entirety.

### REFERENCE TO RELATED APPLICATIONS

This application claims priority to U.S. Provisional Application No. 60/245,135, filed Nov. 2, 2000.

### BACKGROUND OF THE INVENTION

1. Field of the Invention

This invention relates to methods for conducting a televised game show, supported by revenue from commercial advertisers, but which is free of commercial breaks, and to the resulting game show itself.

2. Description of Relevant Art

A number of network television game show concepts have been developed relating to various games that allow a large number of individuals to participate and compete for one or more prizes.

For example, U.S. Pat. No. 5,108,115 (Berman et al.) discloses an interactive communications system for game participants. Game show audience members and home viewer members pick numbers from a total pool of numbers. Six random numbers are then selected from the pool, and the individual's selection that matches the random selection wins the prize.

U.S. Pat. No. 5,545,088 (Kravitz et al.) discloses a television game, which is played interactively by home viewers, a studio audience and on-stage contestants. The game is similar to bingo with the numbers chosen randomly or selected by the contestants upon correctly answering a question.

In all cases, however, the primary source of revenue for television networks that produce and televise game shows is commercial advertisements. The exception, of course, is programming on public broadcasting networks, which are supported by donor contributions. However, game shows are not carried by public broadcasting stations. Otherwise, product manufacturers or distributors pay the broadcasting networks to advertise their products on game shows or any other type of programming. The purpose of a commercial advertisement is to promote a manufacturer's product or products, and to increase product recognition and brand equity. As a result, game shows that are shown on network television are frequently interrupted for commercials in order to show commercial advertisements and generate revenue.

Thus, there has remained, until the present invention, a need for a game show that is shown on network television that can be produced without commercial interruptions, while at the same time generate revenue for the television network.

### SUMMARY OF THE INVENTION

The present invention provides a new game show that commingles advertising with entertainment, developed and broadcast by a national network, with an Internet advertising support system link to the show. The ability to participate and win on the show will not be hindered due to the lack of knowledge, education, worldliness, financial background or intelligence. The show is dedicated to the everyday “Anyone.” No one should be unable to play or win on this show, with the possible exception of certain individuals who are mentally impaired or physically unable to respond to the questions.

One embodiment of the invention provides a method for conducting a network televised, commercial-free game show in which revenue-generating advertisements and entertainment are integrated, wherein the method comprises the steps of:

(a) selecting a predetermined number of contestants to participate in each game, and providing each contestant with the rules for playing the game;

(b) providing each contestant with a square game board comprising a set of unlighted squares each of which contains one of a set of randomly generated numbers, wherein the squares are in an equal number of rows and columns, which is an odd number, and in which the center square on the board is a free square;

(c) displaying a segment of an advertiser's commercial to all contestants and to the public;

(d) receiving a response from a contestant concerning the commercial segment; wherein a correct response identifies the product displayed in the commercial segment and the brand related thereto;

(e) lighting a square of the game board of the contestant making the correct response, wherein no square is lighted if the response is incorrect;

(f) displaying the advertiser's commercial in it's entirety, then

(g) repeating steps (c) through (f) until a contestant's game board has all consecutive horizontal, vertical or diagonal spaces in a single, straight line lighted, at which point the first contestant to do so wins a predetermined prize.

In another embodiment of the invention, the previously described method further comprises playing a round-up session, whereby a contestant selected to play the round-up session can, by properly identifying selected products and brands shown in a series of advertisement segments, select to add to his own contestant game board all of the previously lighted squares from the contestant game board of another contestant. However, in an alternative embodiment of the invention the previously described method further comprises playing a round-up session, whereby a contestant selected to play the round-up session loses all previously lighted squares on his contestant game board by failing to properly identifying selected products and brands shown in a series of advertisement segments.

Also provided is the game show produced by the previously described methods.

Further provided is a method of generating revenue from a network-televised, commercial-free game show in which revenue-generating advertisements and entertainment are integrated. The show generates revenue from both the network broadcast and the Internet. However, the generation of revenue is unique when compared with standard, advertisement-based television protocols. In effect, the entire format of the show is unique because advertising in the new show is an integral and continuous part of the show. A novel feature of the present invention is that the game show itself has no “breaks” for commercials, and none are needed to generate revenue. In fact, the show is continuous in its entirety.

Additional objects, advantages and novel features of the invention will be set forth in part in the description, examples and figures which follow, and in part will become apparent to those skilled in the art upon examination of the following, or may be learned by practice of the invention.

### DESCRIPTION OF THE DRAWINGS

The foregoing summary, as well as the following detailed description of the invention, will be better understood when read in conjunction with the appended drawings. For the purpose of illustrating the invention, there are shown in the drawings, certain embodiment(s), which are presently preferred. It should be understood, however, that the invention is not limited to the precise arrangements and instrumentalities shown.

FIG. 1 is a diagram of an exemplary studio layout according to a preferred embodiment of the present invention. The Commercial Screen, used for viewing the advertiser segments, is flanked by three Contestant Game Boards (C.B.) on each side, and the Host Board (H.B.) in the center.

FIG. 2 is a diagram of an exemplary contestant board layout.

### DESCRIPTION OF A PREFERRED EMBODIMENT OF THE INVENTION

The present invention comprises a method for conducting a game show that anyone can win, wherein advertising in the new show is an integral and continuous part of the show. There are no commercial breaks. Instead, the present game show runs continuously through the allocated programming time without interruption, and the advertising becomes an integral part of the entertainment of the game itself. In fact, revenue is generated for the show, the network and the advertisers in a number of creative ways.

The game can be played for any length of time, but typically the show will run for 30 or 60 minutes.

The show generates revenue from both the network broadcast and the Internet link. The show contains a different content for every broadcast, and each show has numerous winners during each broadcast. Even the contestants that do not win in the game part of the show are given an additional chance to win an alternative prize at the end of the broadcast. Moreover, the show can be moved to any place in the country for taping or broadcasting, which creates free publicity and generates additional revenue, and permits additional advertising sponsors to be attracted.

Revenues from the show can be generated solely from advertising because in the present method advertising is presented to the players and the viewers in a number of different formats. For example, as a primary resource, advertisers pay a fee when their products or brand name is shown or used on the game show, just as they would for a commercial advertising spot (“commercial break”) in a traditional television broadcast. In an equivalent time period, such as an hour, the game show will present at least as many, if not more, commercial advertising opportunities, albeit in a different format, when compared with a traditional game show, which is interrupted by numerous commercial advertisements. However, because people participating in and viewing the show actually participate in advertiser brand recognition, the advertisers get more positive product exposure for their advertising dollar than they would by a traditional television broadcast.

Moreover, in the present game show concept, viewers are unable to turn the channel or leave the room during the advertising portions of the show without missing part of the show itself. More importantly, there is no incentive for them to do so since the essence of the entertainment is to guess or identify the advertiser or manufacturer and its products on the show.

Viewers can qualify as contestants on the show 24 hours a day by viewing advertising segments via the Internet. The Internet advertising is interactive. Consequently, the advertisers again gain additional brand, company or product recognition for their advertising dollar. Viewers can read the advertisements on the Internet and participate in survey information when qualifying for a show, which also provides useful information for the advertisers' databanks. The possibility of selling the survey information offers an addition source of revenue to the show.

Advertiser's paraphernalia (sample products, T-shirts and other wearing apparel naming the advertiser and the like) will also be given away during each show, providing a third opportunity for brand, company or product recognition and commitment.

By “product” is meant the actual product or service described or demonstrated in the advertising medium. The “company” refers to the manufacturer or distributor described in the advertising medium. These meanings will, of course, depend upon the advertisement itself and the “brand” being advertised. For example, General Motors manufactures many different vehicles under different divisions. The correct answer if a contestant were shown an advertisement of a truck might be the “Durango” truck made by the Dodge division—not General Motors. The purpose, therefore, of that particular advertisement, is to promote brand recognition for Dodge—not General Motors. By comparison, however, another advertisement may focus on the GM brand itself.

The invention is further described by example of a preferred embodiment. This embodiment, however, is provided for purposes of illustration to those skilled in the art, and is not intended to be limiting. Moreover, this embodiment is not to be construed as limiting the scope of the appended claims. Thus, the invention should in no way be construed as being limited to the following embodiment, but rather, should be construed to encompass any and all variations that become evident as a result of the teaching provided.

The Game

Variations may be made at a number of points throughout the rules or progress of the game as embodied below, and the value of the cash prize may vary or another high value prize may be substituted, as would be understood by those familiar with game shows. However, such variations are intended to be within the scope of the invention, so long as the resulting program contains the basic elements of continuity of entertainment and advertisement without commercial breaks, and so long as play proceeds through the “rounds” essentially as described below, in which the object remains to be the first player to give the correct answer and to get all of the squares lighted on his/her Game Board in any give straight-line direction.

Object of the Game is to Win:

The first contestant who gets 7 numbers in a row on the game board, in any direction, vertically, horizontally or diagonally, including using the center bonus $ square, wins the game and a prize, e.g., $100,000.00 in cash. The principle is that anyone can win.

Playing the Game:

Before the start of game the host explains the rules of the game to the contestants. In the present embodiment, there are 6 contestants, but the number could be varied, as would be recognized by one familiar with game shows and their operation. Following an introduction, the Host tells the contestants “Let's begin.”

The Host stands before the contestants at a podium fitted with activation buttons. The Host pushes a button at his podium to activate each of six Contestant Game Boards. Contestants' Game Board squares blink, then numbers appear in each of the board squares. A “$” appears in the center square of each of their 7 square by 7 square game boards. Thus, there is the center “$” or “wild card” square and 48 additional squares available on each contestant's game board, into each of which a random computer-generated number between 1 and 60 appears.

The goal of the game to win is to be the player to get all of the squares in a row in any given straight-line direction lighted on his/her Contestant Game Board.

The Buzzer Round:

In the first Buzzer Round the Host shows a brief segment (typically no more than 5-10 seconds long) of a commercial advertisement, from which each contestant tries to guess what product is being advertised, and which company makes or distributes the product (the “brand”).

There is a buzzer before each contestant, and whoever hits his/her buzzer first gets to provide an answer to the Host. The buzzers are mutually exclusive, so that activation of the first buzzer deactivates all other contestants' buzzers. To be correct, the contestant's answer must identify both (i) the product shown in the advertising segment and (ii) the brand or company that markets the product. The correct answer is determined by an unbiased show judge should a question be raised regarding the answer.

After the contestant answers (right or wrong), the host plays the commercial in its entirety (typically 30-60 seconds long).

If the contestant's answer was correct (i.e., the contestant properly identified both the product and the company), the host pushes a button on his podium or a hand held button. A new game board (the “Host Board”) with only one square will light up containing a random computer-generated number between 1 and 60 or the number 100.

Next, the number that is lighted on the Host Board will become lit on each and every Contestant's Game Board that also shows that number, regardless of whether they were the contestant who provided the first answer or not. In fact, the contestant that answered correctly, initiating the display of the number on the Host Board, may not benefit if that individual does not have the lighted number on his/her Contestant Game Board.

For example, if the number “2” appears on host board, each contestant with the number “2” on his/her board will have the number “2” lighted on his/her game board. The Contestants' Game Boards remain visible to the audience and to all contestants throughout the game.

In addition, the contestant who correctly answered the commercial segment question gets to pick any square (as long as it is not currently lit up on his/her board, and it is not the “$” square since this is a free square) as a bonus square on his/her board. The selected square is then lighted on the game board of the contestant who gave the correct answer.

On the other hand, if the contestant's answer is wrong, no number is generated on the Host Board, and no corresponding number is lit on the Contestants' Game Boards. There is, however, no additional penalty for an incorrect answer. The host simply goes on to show the next brief commercial advertising segment to be identified by the contestants, and the process begins again.

Following either an incorrect answer, or the completion of the Host Board segment of the Buzzer Round following a correct answer, the play returns to the beginning of the Buzzer Round and another brief commercial advertising segment is shown to the contestants for identification of product and associated company. In the second pass through the Buzzer Round, however, certain squares on the Contestant Game Boards may already be lit.

The Round-Up Session.

If in selecting the random number after a contestant's correct answer, a predetermined number, in this embodiment the number “100,” appears on the Host Board, this initiates a “Round-Up” session. The contestant who correctly gave the answer that caused the “rounder” number 100 to be generated, is given the opportunity to choose whether he/she will answer the “rounder” segment, or whether he/she would prefer to pass the opportunity to answer to another contestant. After the first contestant decides who will answer, the host shows another commercial segment. However in the Round-Up Session the “segment” actually consists of three (3m) commercial segments in a row.

The Round-Up Contestant, whether it is the first contestant to give the correct answer or whether it is the “selected” contestant who was selected to answer by the first contestant, must provide an answer to each of the three (3) segments. To be correct, the Round-Up Contestant must provide correct answers to all three segments (i.e., the round-up contestant must properly identify the product shown and its corresponding company or brand for each of the three commercial segments).

If the Round-Up Contestant gives the correct answer, he/she gets to “round up” another contestant's board. This means that if correct, the Round-Up Contestant gets to select the board of another contestant, and round up the lighted squares of that contestant's Game Board onto his/her own. The process causes squares on the Round-Up Contestant's board to become lighted that were lit on that other contestant's Game Board, but that had not been previously lit on the Round-Up Contestant's Game Board.

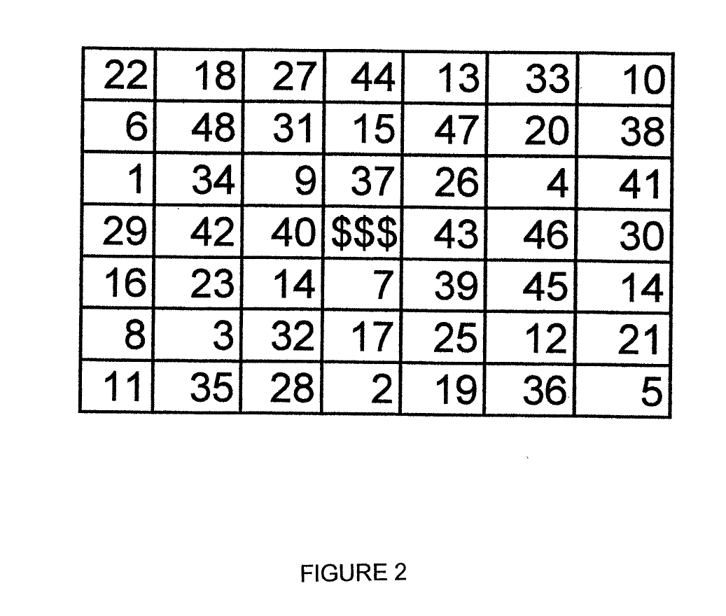

For example, if the top left corner number is a “22,” as shown on FIG. 2, and it is not lighted on the round-up contestant's board (assuming he/she answered correctly in the Round-Up Session), and assuming the Round-Up Contestant could win the game by having that “22” lighted, he/she would choose another contestant's Game Board which has that particular comer lighted (the “Round-Up Donor”). Even if it that comer of the round-up donor's board shows a different number, the Round-Up Contestant would select that board to win the game.

Thus, the round-up donor's squares are “rounded” onto the Round-Up Contestant's Game Board on a square-by-square basis—by location, not by number. Consequently, the actual number in the Round-Up Donor's board is irrelevant. It is the location of the lighted square that is transferred to the Round-Up Contestant's Game Board, permitting him/her to get the correct number of lighted squares in a row, regardless of the actual number within the square.

The contestant who was “rounded” (i.e., the Round-Up Donor) continues to keep his/her squares lighted after the Round-Up Session, unless the Round-Up Contestant wins by “rounding-up,” which ends the game.

On the other hand, if the answer given by the Round-Up Contestant is wrong, the Round-Up Contestant's entire game board is stripped of all lighted squares, forcing that unfortunate Round-Up Contestant to begin the game again, although he/she is permitted to continue playing the game until someone wins. If there is no winner after the Round-Up Session, all the contestants continue to play the game, and a new commercial segment is shown in a new Buzzer Round to the same six contestants. This gives them an opportunity to answer by naming the correct product and brand or company as above.

By allowing the contestant who caused the number “100” to appear on the Host Board to choose whether he/she plays the Round-Up Session or whether an opponent plays the Round-Up Session, allows that contestant to selected either a defensive or an offensive strategy. It also keeps the audience more involved in second-guessing the outcome.

The process of showing advertiser segments in Buzzer Rounds is continued until one of the contestants wins the game, i.e., finally gets a full, straight line of squares lit in any direction. This ends Game 1, after which another game, Game 2, begins with the same Host, but with all new contestants, repeating the foregoing process according to the same rules. Games continue to be played (Games 3, 4, etc) and won, until the broadcast time is within five minutes of the predetermined time for the show to end.

Final Chance to Win

As previously stated, every show has at least one winner, and no show has a commercial “break,” since the commercials are incorporated into the body of the show. In the last five (5) minutes of the show, any non-winning contestant is brought to the front of the Host Board. Then, each non-winner is randomly given an envelope containing a number from 1-*, wherein the * represents to total number of non-winners on that particular show). Next, the Host presses a button that causes a computer-generated random number to be selected from within the range of 1-*.

The holder of that selected number from among the non-winners on that particular show, wins a prize provided by one of the sponsors of the show, at which point an advertising commercial segment representing that sponsor is then shown relating to that prize.

End of the Show

The show ends when the Host says “Goodnight” and reminds the audience that “until next time remember, you or anyone can win!” The show is repeated on a regularly occurring schedule, and each show repeats the game with new contestants. In a 30-minute show, it is expected that at least 15-20 advertiser segments will be shown to the contestants, the audience and the public. In a 60 minute show, that number would be at least doubled.

Year End Show

The last show (which may actually be a series of shows) of season or at year-end, has a grand prize of, e.g., a $5,000,000.00 annuity. This show is played according to the same rules as described above, but it is played in rounds in which the contestants are all the winners from the previous year.

How to Get on the Show

Contestants are selected by any of the following methods:

1) By sending a postcard to a pre-identified Post Office (PO) box for random selection.

2) By appearing at the studio set and being randomly picked out of the crowd. If you are not picked to participate on the show, you could also be picked to watch the show. Those watching the show in studio could also be picked randomly at the time of the filming of the show to participate on that show.

3) By logging onto the Internet and reading the commercial advertisements provided therein, and answering questions about them. Interested parties get an opportunity to apply to be a contestant on the show for every group, e.g., 5, advertisements read and responded to, and they can apply as often as they wish.

For example, for every show that has 6 contestants per game, at least two contestants will have been selected from each entry category—2 from post box applicants, 2 from the studio audience, and 2 from the Internet applicants. Additional contestants, if needed, are picked randomly form entries via Internet and postcards.

Revenues

Revenues for the television productions are generated from:

1) Advertising—payment for commercial advertising segments used on the show. (Longer segments could require higher payment by the advertiser to be presented on the show; and the Year-End Show or special shows may also require advertisers to make premium payments to have their advertisements included in the show.)

2) Internet advertising—payment by manufacturers whose advertisements are read by participants trying to become a contestant on the show; and

3) Sponsors of each show that provide the prize for the non-winners at the end of each show, and whose advertisement is then shown.

Studio Set

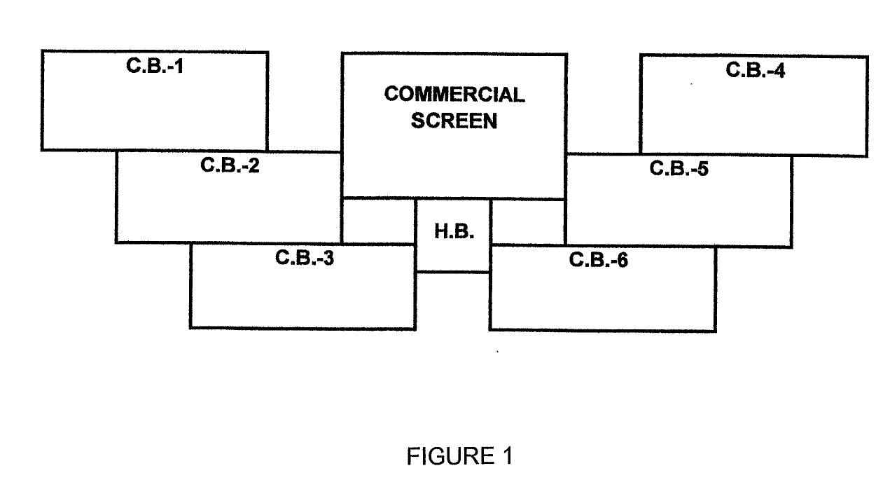

FIG. 1 shows one studio layout, although numerous others are possible, as would be recognized by those in the television industry familiar with game show formats. The layout includes a studio-in-the-round style, with the Commercial Screen for viewing the advertiser segments, flanked by three Contestant Game Boards (C.B.) on each side, and the Host Board (H.B.) in the center. This format allows the audience to see everything from any seat, facilitates television camera coverage, and allows for creativity in the development of the set. Each contestant has his/her game board in front of him/her on a monitor screen, permitting both the contestant and the audience to track everyone's progress.

This game show will attract a very large viewing audience because it is so simple and easy to win. It also creates a market of advertising in which viewers not only will see and learn to recognize the product, but they will also gain a reinforced association between brand name and product, without losing viewer participation. This enables the network to add value for the advertisers. The advertising for the Internet link and the television game show (network) are intertwined.

Advantageously this show can be produced and shown anywhere, and could even be a travelling show, if production costs allow, stopping at points across the country; creating more publicity and marketing hype among viewers.

Everyone has a chance to win on this show—and as a result, anyone who watches the show will think that if they could get on the show, they too could be the next winner. Thus, as show ratings increase, advertising dollar demand will increase for the products shown on the show.

Alternative Embodiments

It will be appreciated that, although specific embodiments of the invention have been described herein for purposes of illustration, various modifications may be made without departing from the spirit and scope of the invention. For example in a preferred embodiment, the show can is adapted to younger audiences, e.g., ages 16-22, or even younger, by changing the advertising content and the winnings. Even elementary school children could be contestants, or the program could have an educational value. If the advertising is geared toward a younger age, the show might be better aired on networks like Disney, MTV or a Saturday morning time slot. The winnings could include spring break packages, college tuition, computers, bikes and other recreational items.

In an another embodiment, celebrity shows could include celebrity contestants and the prize money or prizes could be directed to one or more charities. A particular show could focus entirely on a charitable purpose, such as the American Red Cross, or each celebrity contestant could have his/her own selected charity to which his/her winnings are directed. In a variation of this embodiment, contestant teams could respond to the advertiser segments, in which contestants selected as described above could be paired with celebrities.

In yet another embodiment, the entire show could have e.g., without limitation, a college theme, a wedding theme, or a music or sports theme, with contestants selected accordingly. The contestants could even operate in pairs, such as newly married couples answering together on a wedding theme show. For those shows the advertisers may also be selected from those manufacturers or distributors relevant to the show's theme.

Each and every patent, patent application and publication that is cited in the foregoing specification is herein incorporated by reference in its entirety.

While the foregoing specification has been described with regard to certain preferred embodiments, and many details have been set forth for the purpose of illustration, it will be apparent to those skilled in the art that the invention may be subject to various modifications and additional embodiments, and that certain of the details described herein can be varied considerably without departing from the spirit and scope of the invention. Such modifications, equivalent variations and additional embodiments are also intended to fall within the scope of the appended claims.

What is claimed is:

1. A method for conducting a network-televised, commercial-free game show in which revenue-generating advertisements and entertainment are integrated, wherein the method comprises the steps of:
(a) selecting a predetermined number of contestants to participate in each game, and providing each contestant with the rules for playing the game;
(b) providing each contestant with a square game board comprising a set of unlighted squares each of which contains one of a set of randomly generated numbers, wherein the squares are in an equal number of rows and columns, which is an odd number, and in which the center square on the board is a free square;
(c) displaying a segment of an advertiser's commercial to all contestants and to the public;
(d) receiving a response from a contestant concerning the commercial segment; wherein a correct response identifies the product displayed in the commercial segment and the brand related thereto;
(e) lighting a square of the game board of the contestant making the correct response, wherein no square is lighted if the response is incorrect;
(f) displaying the advertiser's commercial in it's entirety, then
(g) repeating steps (c) through (f) until a contestant's game board has all consecutive horizontal, vertical or diagonal spaces in a single, straight line lighted, at which point the first contestant to do so wins a predetermined prize.

2. The method of claim 1, further comprising an Internet link for viewing advertisement segments by potential contestants seeking an opportunity to qualify as contestants on the network televised game show.

3. The method of claim 2, further comprising interacting at an Internet Web site with responses to at least one advertiser survey.

4. The method of claim 1, wherein the contestant game board comprises 49 squares, configured in a 7 square by 7 square pattern, and one additional center free square.

5. The method of claim 4, wherein the set of randomly generated numbers to be placed within each square in step (b) comprises computer-generated numbers ranging from 1 to 60, plus one additional preselected number greater than 60.

6. The method of claim 1, further comprising the lighting of a previously unused random number on a Host Board to indicate which numbered square is lighted in the contestant game boards in step (e) in response to a correct contestant answer.

7. The method of claim 1, further comprising playing a round-up session, whereby a contestant selected to play the round-up session can, by properly identifying selected products and brands shown in a series of advertisement segments, select to add to his own contestant game board all of the previously lighted squares from the contestant game board of another contestant.

8. The method of claim 7, wherein the playing of the round-up session is triggered by the appearance of a predetermined Host Board number, which is greater than the highest of the randomly selected numbers in step (b).

9. The method of claim 1, further comprising playing a round-up session, whereby a contestant selected to play the round-up session loses all previously lighted squares on his contestant game board by failing to properly identifying selected products and brands shown in a series of advertisement segments.

10. The game show produced by the method of claim 1.

11. The method of generating revenue from a network-televised, commercial-free game show in which revenue-generating advertisements and entertainment are integrated, wherein the method comprises producing such a network televised, commercial-free game show played according to the steps set forth in claim 1.
